(19) United States
(12) Patent Application Publication
(10) Pub. No.: US 2021/0102554 A1
(43) Pub. Date: Apr. 8, 2021

(54) MULTI-STAGE COMPRESSOR UNIT AND METHOD FOR ADJUSTING THE ROTATIONAL SPEED OF THE MOTORS

(71) Applicant: ATLAS COPCO AIRPOWER, NAAMLOZE VENNOOTSCHAP, WILRIJK (BE)

(72) Inventor: Thomas Willem I. DE BONTRIDDER, Wilrijk (BE)

(73) Assignee: ATLAS COPCO AIRPOWER, NAAMLOZE VENNOOTSCHAP, WILRIJK (BE)

(21) Appl. No.: 17/041,007

(22) PCT Filed: Feb. 11, 2019
(86) PCT No.: PCT/IB2019/051075

§ 371 Date: Sep. 24, 2020

Related U.S. Application Data
(60) Provisional application No. 62/656,472, filed on Apr. 12, 2018.
(60) Provisional application No. 62/724,677, filed on Aug. 30, 2018.

(30) Foreign Application Priority Data
Nov. 2, 2018 (BE) 2018/5769

(51) Int. Cl. F04D 29/58; F04D 25/06; F04D 17/12; F04D 27/00

(52) U.S. Cl. CPC F04D 29/5806; F04D 25/06; F04D 27/004; F04D 17/12; F04D 27/001; F04D 29/5826

(57) ABSTRACT

A multi-stage compressor unit including at least a first compressor stage including a first compressor element driven through a first gear-transmission and a second compressor stage including a second compressor element driven through a separate second gear-transmission. The first and second gear transmissions include a driving gear and a driven gear configured to be a multiplier, each of the driven gears is connected to a shaft of a rotor of the first compressor element or second compressor element respectively, where the first motor and the second motor re adapted to drive the first compressor stage and the second compressor stage separately. The gear ratio between the driven gear and the driving gear of either one of the first gear transmission and second gear transmission is situated between two and six.

This invention relates to a multi-stage compressor unit comprising an inlet and a compressed gas outlet, at least a first compressor stage comprising a first compressor element driven by a first motor through a first gear-transmission and a second compressor stage comprising a second compressor element driven by a second motor through a separate second gear-transmission, whereby each of said first and second gear transmissions comprises a driving gear connected to the first motor or the second motor respectively, and a driven gear configured to be a multiplier, each of said driven gears being connected to a shaft of a rotor of said first compressor element or second compressor element respectively, whereby the first motor and the second motor are adapted to drive the first compressor element and the second compressor element separately.

Multi-stage compressor units are widely used within the industry, such known units typically having at least two compressor stages with compressor elements driven either by the same motor or by separate motors.

If the compressor elements are driven by the same motor, even though these may be reliable, these compressor units experience a limitation in flexibility of the speed regulation of the two compressor stages.

An example of a two stage compressor whereby each stage comprises a motor driven through an inverter can be found in WO 2017/169,595 A.

In yet another example, WO 01/31202, a multi-stage compressor is provided whereby the compressor elements of the compressor stages are driven separately based on the pressure measured at the outlet of the multi-stage compressor.

Typically, these known compressor units are incorporating a rather big motor being driven at low speeds, making them inefficient in terms of manufacturing costs and in terms of operational costs since the motor is not used at its full capacity.

Taking the above mentioned drawbacks into account, it is an object of the present invention to provide a multi-stage compressor unit allowing an increase in flexibility for adjusting the speed of the different compressor stages depending on their respective parameters.

It is another object of the present invention to provide a multi-stage compressor unit that is efficient both in terms of manufacturing costs and operational costs.

Yet another object of the present invention is to provide a solution for using at high capacity the motors driving the compressor elements of different compressor stages.

The present invention solves at least one of the above and/or other problems by providing a multi-stage compressor unit comprising an inlet and a compressed gas outlet, at least a first compressor stage comprising a first compressor element driven by a first motor through a first gear-transmission and a second compressor stage comprising a second compressor element driven by a second motor through a separate second gear-transmission, whereby each of said first and second gear transmissions comprises a driving gear connected to the first motor or the second motor respectively, and a driven gear configured to be a multiplier, each of said driven gear being connected to a shaft of a rotor of said first compressor element or second compressor element respectively, whereby the first motor and the second motor are adapted to drive the first compressor element and the second compressor element separately wherein the gear ratio between the driven gear and the driving gear of either one of said first gear transmission and second gear transmission is situated between two and six.

By adopting such a gear ratio between the driven gear and the driving gear of either one of said first and second gear transmissions, the multi-stage compressor unit according to the present invention can incorporate smaller motors which are driven at a higher speed while still meeting the demand of the user, increasing the efficiency of the multi-stage compressor unit, when compared with existing compressor units.

Therefore, because the motors are smaller, not only the operational efficiency of the multi-stage compressor unit is increased, but also the manufacturing costs are decreased.

Additionally, the energy footprint of a multi-stage compressor unit according to the present invention also becomes smaller.

Furthermore, by using smaller motors, the dimensions and weight of the multi-stage compressor unit decrease.

Because of this, the manipulation of the multi-stage compressor unit becomes easier not only during manufacturing but also during transport.

By using such a layout, the rotational speeds of the rotors of the respective compressor elements are higher than the respective rotational speed of the motors, increasing the efficiency of the multi-stage compressor unit.

In fact, due to this layout, the rotors of the first compressor element and of the second compressor element reach the same speeds by using a small motor as they would have reached by using a big motor. This translates into a reduction in overall manufacturing costs and in complexity of the system, since a smaller motor would require the usage of conventional materials, conventional connection means and conventional controls.

The present invention is further directed to a method for adjusting the rotational speed of the motors of a multi-stage compressor unit, wherein the method comprises the following steps:
providing a first compressor stage comprising a first compressor element and driving said first compressor element by means of a first motor through a first gear-transmission;
providing a second compressor stage comprising a second compressor element and driving said second compressor element separately from the first compressor element by means of a second motor through a separate second gear-transmission;
connecting a driving gear of each of the first gear-transmission and second gear-transmission to the first motor or second motor respectively;
connecting a driven gear of each of the first gear-transmission and second gear-transmission to a shaft of a rotor of said first compressor element or second compressor element respectively
   wherein the method further comprises the step of setting the gear ratio between the driving gear and the driven gear of either one of said first gear-transmission and second gear-transmission between two and six.

The present invention is further directed to a multi-stage compressor unit comprising at least a first compressor element and a second compressor element and at least a first motor and a second motor for driving, each separately, another one of said first compressor element and second compressor element through a separate first gear-transmission and second gear-transmission, each of said first gear-transmission and second gear-transmission comprising a driving gear connected to a respective motor of said first motor or second motor, and a driven gear being connected to a shaft of a rotor of one of said first compressor element or second compressor element, wherein the ratio between the number of teeth of the driving gear and the number of teeth of the driven gear of either one of said first gear-transmission and second gear-transmission is situated between two and six.

In the context of the present invention, it should be understood that the benefits presented above with respect to the multi-stage compressor unit are also valid for the method for adjusting the rotational speed.

With the intention of better showing the characteristics of the invention, some preferred configurations according to the present invention are described hereinafter by way of an example, without any limiting nature, with reference to the accompanying drawings, wherein:

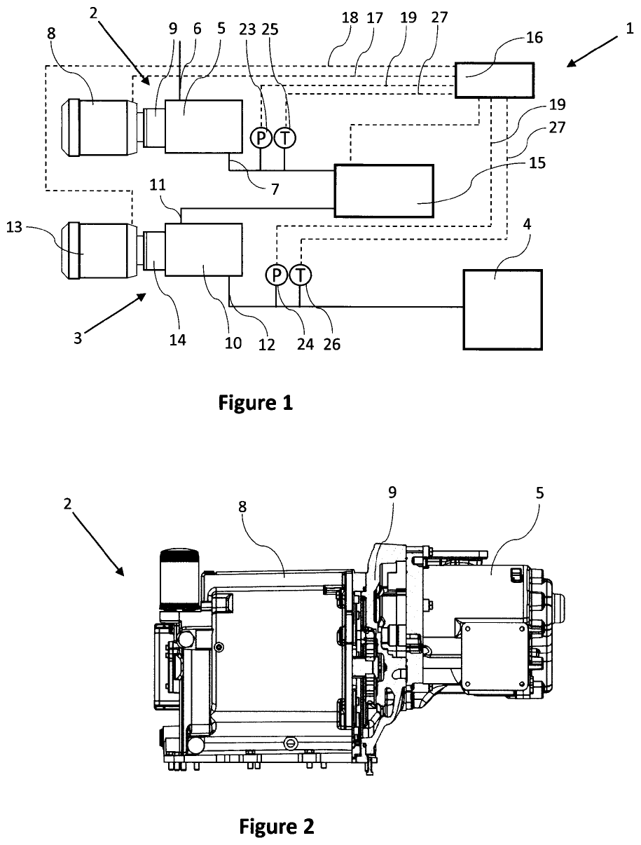

FIG. 1 schematically illustrates a multi-stage compressor unit according to an embodiment of the present invention;

FIG. 2 schematically illustrates an example of the first compressor stage according to an embodiment of the present invention;

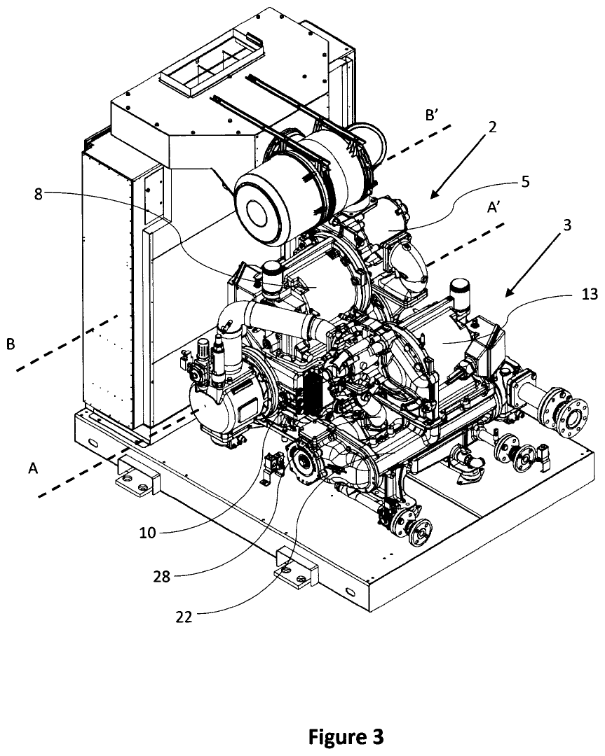

FIG. 3 schematically illustrates a multi-stage compressor unit according to an embodiment of the present invention;

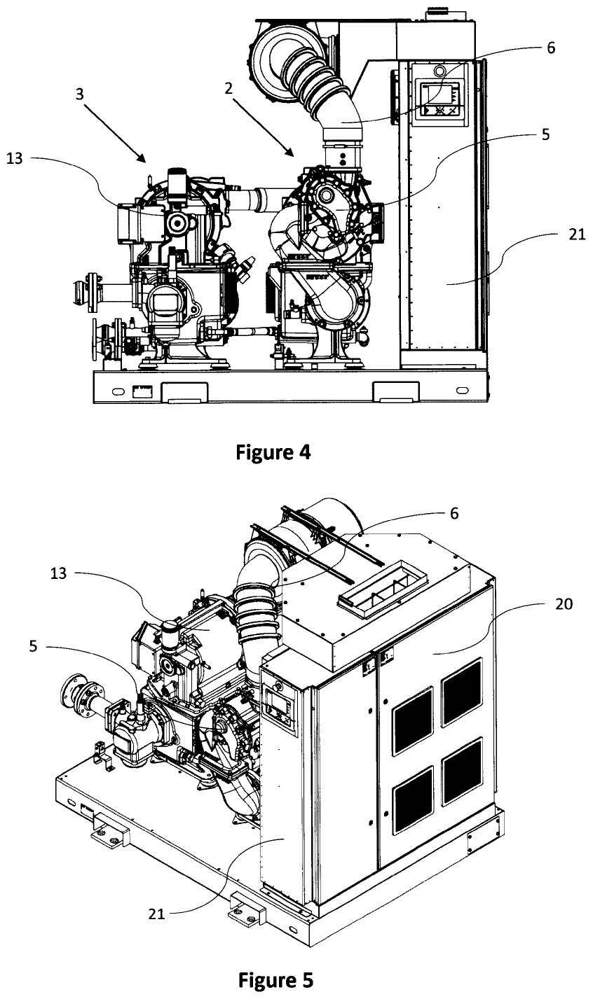

FIG. 4 schematically illustrates a lateral view of the multi-stage compressor unit according to FIG. 3;

FIG. 5 schematically illustrates a rotated view of the multi-stage compressor unit of FIG. 3;

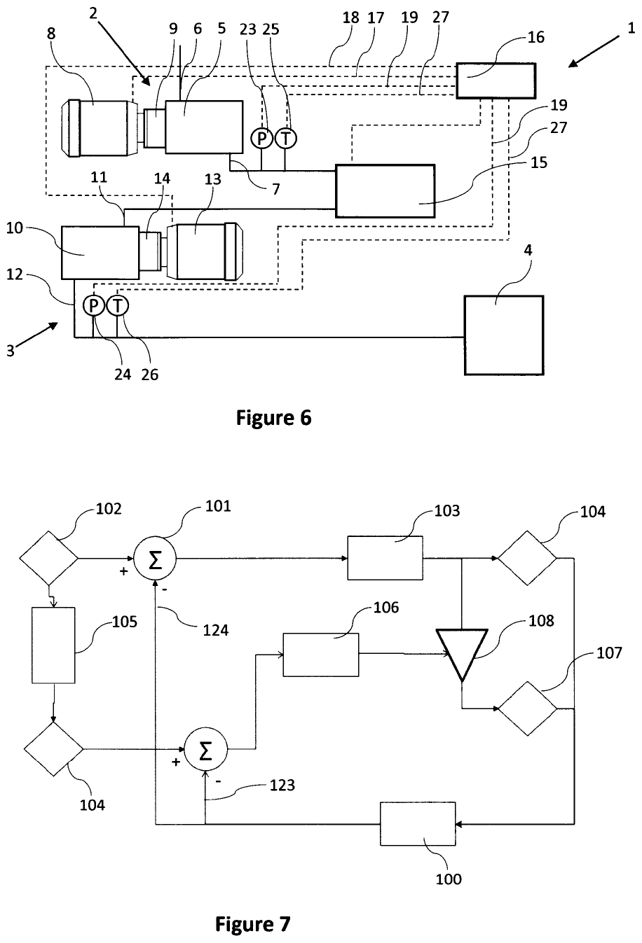

FIG. 6 schematically illustrates a multi-stage compressor unit according to another embodiment of the present invention; and

FIG. 7 schematically illustrates a flow chart representation of the method according to an embodiment of the present invention.

FIG. 1 illustrates a multi-stage compressor unit 1, in this case in the form of a two stage compressor unit comprising a first compressor stage 2 and a second compressor stage 3 supplying compressed gas to a user's network 4.

Said first compressor stage 2 comprising a first compressor element 5 having an inlet 6 and a compressed gas outlet 7.

The first compressor element 5 being driven by a first motor 8 through a first gear-transmission 9.

Typically such a gear-transmission 9 is received within a housing, the assembly typically being known as a gearbox.

Similarly, the second compressor stage 3 comprises a second compressor element 10 having an inlet 11 and a compressed gas outlet 12. The second compressor element 10 being driven by a second motor 13 through a second gear-transmission 14.

Because of such a layout, an independent speed regulation is achieved.

It should however not be excluded that the multi-stage compressor unit 1 according to the present invention can also comprise more than two compressor stages, like for example and not limiting thereto: three, four or even more.

In the context of the present invention, the multi-stage compressor unit 1 should be understood as the complete compressor installation, including the compressor elements 5 and 10, all the typical connection pipes and valves, the canopy and possibly the motors 8 and 13 driving the compressor elements 5 and 10.

In the context of the present invention, the compressor element should be understood as the compressor element casing in which the compression process takes place, typically by means of one or more rotors.

Each of said first gear-transmission 9 and second gear-transmission 14 comprising a driving gear and a driven gear mated with each other.

Considering the first compressor stage 2, the driving gear is being mounted onto a motor shaft of a rotor of said first motor 8, and the driven gear is being mounted on one shaft of the first compressor element 5.

Similarly, the driving gear of the second gear-transmission 14 is being mounted onto a motor shaft of a rotor of said second motor 13 and the driven gear is being mounted on one shaft of the second compressor element 10.

During functioning, the motor shaft and consequently the driving gear rotates, making the driven gear and, consequently, the rotors in the compressor element 5 to rotate as well.

Because the driven gear is constructed as a multiplier, the rotational speed of the driven gear, during operation, is higher than that of the driving gear. Consequently, the rotors in the first compressor element 5 and in the second compressor element 10 will reach higher rotational speeds than the rotor of their respective motors.

Each of said first compressor element 5 and second compressor element 10 typically comprising two rotors: a male rotor and a female rotor (not shown) intermeshing with each other.

Each of said rotors comprising a shaft, whereby preferably, but not limiting thereto, the shaft of the male rotor is being connected to the driven gear of the respective gear-transmission.

It should not be excluded that the shaft of the female rotor can be connected to the driven gear instead of the shaft of the male rotor.

The use of such a gear transmission offers the advantage of flexibility in terms of speed range.

Furthermore, the lower the gear ratio between the driven gear and the driving gear of said gear transmission the higher the speed of the first motor 8 and of the second motor 13 respectively, enabling potential cost savings. However, above a certain speed additional measures are required to deal with the technical challenges.

Preferably, the gear ratio between the driven gear and the driving gear is situated between two and six, case in which the first motor 8 and the second motor 13 do not require additional measures. Accordingly, the motors are used at high capacity, which translates into lower operational costs.

By choosing a speed ratio between two and six, the maximum and minimum speed of the rotors of the first compressor stage 2 and of the second compressor stage 3 respectively are in fact maintained in a nominal range. Consequently, the temperature within the compressor element casing of the first compressor stage 2 and of the second compressor stage 3 can be also maintained within desired limits, protecting the components and potentially increasing the lifetime of the multi-stage compressor unit 1.

By adopting a speed ratio between two and six for the first motor 8 and for the second motor 13, the speed of the respective motor is allowed to be higher than in conventional units, without the need for additional reinforcements and without additional means for cooling the motor or the bearings. Consequently, the operational and manufacturing costs are maintained low.

In conventional systems, the gear ratio between the rotor of the motor and the rotor of the compressor element is typically chosen above 6, such systems incorporating a bigger motor functioning at low speed. Since the motor is not driven at its full capacity, the efficiency of the system is not optimal and the operational costs are higher.

Newer systems would choose a gear ratio of below 2 in order to increase the efficiency, but by going to such high speeds, additional reinforcements of the rotor of the first motor 8 and of the second motor 13 would be required.

Moreover, a bigger motor would require special connection elements and materials that could resist the high vibrations and high temperatures encountered when it is driven at full capacity.

Additionally, high rotating speeds of the first motor 8 and/or of the second motor 13 require high switching frequencies of the frequency convertor, which means bigger challenges in terms of controls.

Furthermore, such high rotational speeds would require special materials used for the manufacturing of the motor, special means to contain the magnets therein and special cooling means.

In a preferred embodiment according to the present invention, but not limiting thereto, said first and second compressor elements 5 and 10, can be selected as screw or toothed compressor elements, either oil free or oil injected.

In another preferred embodiment according to the present invention, each of said first motor 8 and second motor 13 comprise a frequency converter (not shown) for changing the rotational speed of the respective motor 8 and 13.

In a preferred embodiment according to the present invention, the first motor 8 and the second motor 13 allow for a change of speed through each of the frequency converters independently from each other.

Because the layout of the multi-stage compressor unit 1 is chosen in such a way, not only the flexibility of the system is increased but the multi-stage compressor unit 1 can be adapted in accordance with the specific system conditions.

Consequently, the independent speed regulation allows to improve the performance of the multi-stage compressor unit 1 based on environmental and operational conditions.

In a preferred embodiment according to the present invention, but not limiting thereto, the first compressor stage 2 and the second compressor stage 3 are connected in series. Accordingly, the compressed gas outlet 7 of the first compressor stage 2 is fluidly connected to the inlet 11 of the second compressor element 10, and the compressed gas outlet 12 of the second compressor stage 3 is fluidly connected to the user's network 4 (FIG. 1).

It should be however not excluded that the first compressor stage 2 can be connected in parallel with the second compressor stage 3. In such a case the inlet of the two compressor stages would branch off from a common inlet and the two compressed gas outlets would be connected to a common outlet reaching the user's network.

In a preferred embodiment according to the present invention, the multi-stage compressor unit 1 comprises a cooling unit 15 for cooling a compressed gas exiting the first compressor element 5 or the second compressor element 10.

Such cooling unit 15 being positioned either between the first compressor stage 2 and the second compressor stage 10 or between the second compressor stage 10 and the user's network 4.

Preferably, the cooling unit 15 is positioned on the fluid conduit between the first compressor stage 2 and the second compressor stage 10.

Typically, the cooling unit 15 comprises two sections: a first section of channels through which the compressed gas is flowing and a second section through which a coolant is flowing, the temperature of the coolant typically being much lower than that of the compressed gas. Consequently, the compressed gas leaving the first compressor stage 3 is being cooled by passing through the cooling unit 15, before being directed through the inlet of the second compressor element 10 where it is further compressed.

The coolant in the cooling unit 15 being selected from the group comprising: air, water, oil or any other coolant.

In another embodiment according to the present invention, but not limiting thereto, the coolant can further comprise an additive such as, for example glycol.

In an embodiment according to the present invention, the multi-stage compressor unit 1 further comprises a controller unit 16 connected to the first motor 8 through a first communication link 17 and to the second motor 13 through a second communication link 18.

Preferably, but not limiting thereto, the controller unit 16 is connected through said first communication link 17 to a frequency convertor adapted to increase or decrease the speed of the first motor 8.

In a similar manner, the controller unit 16 is connected through the second communication link 18 to a frequency converter adapted to increase or decrease the speed of the second motor 13.

The controller unit 16 determining the speed of said first motor 8 and of said second motor 13 and generating an electrical signal to each of the frequency converters.

In a preferred embodiment according to the present invention, the multi-stage compressor unit 1 typically comprising a series of sensors like for example: a first pressure sensor 23 and/or a first temperature sensor 25 positioned at the compressed gas outlet 7 of the first compressor element 5 and a second pressure sensor 24 and/or a second temperature sensor 26 positioned at the compressed gas outlet 12 of the second compressor element 10.

By measuring the pressure and/or temperature at the compressed gas outlet 7 of the first compressor stage 2 and at the compressed gas outlet 12 of the second compressor stage 3 and by considering the requirements of the compressed gas at the level of the user's network 4, the rotational speed of the first motor 8 and of the second motor 13 can be determined such that an optimal functioning condition of the multi-stage compressor unit 1 is maintained.

In another embodiment according to the present invention, the controller unit 16 is adapted to receive measurement data from said pressure sensor(s) 23 and/or 24, and/or temperature sensor(s) 25 and/or 26, through a third communication link 19 and a fourth communication link 27, respectively.

During the design of the multi-stage compressor unit 1, the functioning pattern of the compressor unit 1 is determined, by considering the parameters of the different compressor elements, their geometrical dimensions and by considering the ideal behavior while compressing gas. Accordingly, a graphical representation or a matrix is realized whereby the relation between the speed of the motor and the pressure at the compressed gas outlet can be found.

Such a graph or matrix can be used to determine the speed of the first motor 8 and of the second motor 13 based on the respective pressure and/or temperature measurements and the requirements at the user's network.

In another embodiment according to the present invention, the controller unit 16 can further use a representation of the mass flow over pressure of the first compressor element 5 and of the second compressor element 10 to determine the state of equilibrium of the multi-stage compressor unit 1 and change the speed of the first motor 8 and of the second motor 13 such that the state of equilibrium is maintained.

In such a state, the efficiency of the cooling unit 15 is optimum. Additionally, the pressure ratio between the second compressor element 10 and the first compressor element 5 is maintained in nominal parameters which means that the situation in which the pressure difference between the stages would be very high, is avoided. Consequently, the temperature of each of the compressor elements 5 and 10, is not allowed to raise at very high levels, which would potentially affect the functioning of the respective compressor stage 2 and 3.

Accordingly, not only the operational costs are reduced, but also the compressor elements 5 and 10, are protected from reaching very high temperatures, very low or very high pressure levels and the first and the second motor 8 and 13 are protected from running at speeds outside the nominal range.

In an ideal situation, the state of equilibrium is still maintained even when the speed of the first motor 8 and/or of the second motor 13 is/are decreased.

However, in real life situations, tests have shown that the parameters for which the state of equilibrium is reached, shift on the representation of mass flow rate over pressure, once the motors experience a variation of the speed, which can lead to a situation in which the pressure at the compressed gas outlet 7 becomes very high due to a very low speed at which the first motor 8 is being driven.

This situation is unwanted and the controller unit 16 helps in preventing the high pressure values at the compressed gas outlet 7 of the first compressor element 5 and at the compressed gas outlet 12 of the second compressor element 10 by the individual adjustment of the speed of the first motor 8 and of the second motor 13.

Typically, the first compressor element 5 defines the volume of compressed gas that is being delivered at the level of the user's network 4, whereas the second compressor element 10 defines the pressure of the compressed gas delivered at the user's network 4.

If the system reaches a situation in which the speed of the rotors of the first compressor element 5 is significantly reduced due to a change in demand at the level of the user's network and the rotors of the second compressor element 10 are maintained at the same speed, the pressure value at the compressed gas outlet 7 of the first compressor element 5 and consequently the temperature level can increase to very high levels.

The controller unit 16 avoids this situation by the individual adjustment of the speed of the second motor 13 and by considering the measurements of the pressure and/or temperature at the compressed gas outlet 7 of the first compressor stage 2.

Due to such an adjustment of the speed, the speed ranges of the first compressor stage 2 and of the second compressor stage 3 are in fact extended.

Accordingly, when the first motor 8 is running at very low speeds, the pressure and the temperature measured at the compressed gas outlet 7 of the first compressor element 5 become very high, reaching or almost reaching the limit of functioning. When such a situation is encountered, instead of stopping the multi-stage compressor unit 1, an adjustment of speed is preferably performed at the level of the second compressor stage 3. Accordingly, by increasing the speed of the second motor 13, the pressure at the level of the compressed gas outlet 7 of the first compressor element 5 is decreased and the multi-stage compressor unit 1 is therefore maintained in nominal parameters.

In this way, the first motor 8 is allowed to run at even lower speeds than the minimum set up, increasing the reliability of the multi-stage compressor unit 1.

The same is applied if, at the compressed gas outlet 12 of the second compressor element 10, extreme values in terms of pressure or temperature are reached, these values being adjusted through an adjustment of the rotational speed of the first motor 8.

In known compressors, when the first compressor stage is ran at low rotational speeds, the pressure measured at the level of the first compressor element is raising and the leakage encountered at the level of the second compressor element is also increasing, which is detrimental for the functioning of the unit.

However, by using a multi-stage compressor unit 1 according to the present invention, such a situation is avoided.

Accordingly, the first compressor element 5 and second compressor element 10 are being driven separately through separate gear-transmissions, such that a state of equilibrium between the pressure and mass flow rate between the two stages can be maintained by regulating the pressure of the compressed gas at the compressed gas outlet 7 of the first compressor element 5.

By maintaining the state of equilibrium, the multi-stage compressor unit 1 will be more efficient in terms of energy consumption and the compressor stages 2 and 3, will be maintained in nominal working parameters.

Because the first compressor element 5 and the second compressor element 10 are driven separately through the first motor 8 and the second motor 13 and because the gear ratio is situated between two and six, the multi-stage compressor unit 1 makes use of motors that are controlled easier, such motors having a better dynamic control. Consequently, the first motor 8 and the second motor 13 are easily maintained in a stable operating state and are controlled more accurately.

Because the dynamics control of the motors defines the dynamics of the multi-stage compressor unit 1 as a whole, said multi-stage compressor unit 1 can use a simpler software.

In the context of the present invention, the first communication link 17, the second communication link 18, the third communication link 19 and the fourth communication link 27 can be each selected as a wired or a wireless communication link.

In case of a wired connection, an electrical wire is provided allowing for an electric signal to be transmitted there through and connector elements at each end of said wire for connecting the controller unit 16 and the respective component(s).

In case of a wireless connection, a connection between two components comprises a transmitter and a receiver in communication with each other and allowing an electrical signal to be sent there through, or each can comprise a transceiver allowing a communication in both directions.

In an embodiment according to the present invention, at least one of said first motors 8 or second motor 13 is an electrical motor.

In yet another embodiment according to the present invention and not limiting thereto, at least one electrical motor is a VSD (variable speed drive) motor.

The challenges and the related speed ranges are dependent on the size of the electrical motor (2). To overcome this dependence, according to a preferred characteristic of the invention, at least one of the first motor 8 and/or second motor 13 is configured such that the product of the nominal power, in kW, and the square of the nominal speed, in rpm, is situated in a range between 0.0006×10E12 and 0.025×10E12.

Typically the costs associated with a motor decrease with the increase of the value of the product between the nominal power and the square of the nominal speed. Such a situation is encountered until, due to technical limitations, a limit is reached. If such a limit needs to be crossed, more expensive motors and control systems need to be chosen.

In another embodiment according to the present invention, at least one of said first motor 8 and/or second motor 13 can be configured such that the product of the maximum power, in kW, and the square of the maximum speed, in rpm, is situated in a range between 0.0006×10E12 and 0.025×10E12.

In another embodiment according to the present invention the first compressor stage 2 and the second compressor stage 3 are received within a housing (not shown).

To reduce the footprint of the multi-stage compressor unit 1 and to improve the gas flow, it is preferred to orient at least one of said first compressor element 5 or second compressor element 10 and the first motor 8 or second motor 13 driving this at least one first compressor element 5 or second compressor element 10, transversally relative to the direction of longest side of the multi-stage compressor unit 1, and accordingly, the longest side of the housing (FIG. 3).

Typically, the motor driving a compressor element is mounted next to said compressor element and in the continuation of it, since the motor will directly drive a rotor of the compressor element. Due to the gear-transmission, the axis of rotation of the rotor of the compressor element being shifted from the axis of rotation of rotation of the rotor of the respective motors but maintained parallel thereto.

The axis of rotation of the compressor element defining an axis A-A′ as shown in FIG. 3.

Preferably, at least one of said first compressor stage 2 and second compressor stage 3 are mounted such that the axis A-A′ they define is being positioned transversally relative to the direction of the longest side of the of the multi-stage compressor unit 1.

Preferably, but not limiting thereto, both the first compressor element 5 and the first motor 8 and the second compressor element 10 and the second motor 13 are oriented transversally relative to the direction of longest side of the multi-stage compressor unit 1 and accordingly, the longest side of the housing.

For reasons of standardization, preferably, identical electrical motors are used for different compressor elements. More specifically, the dimensions of the motors are preferably identical.

For reasons of electromagnetic compatibility the frequency convertors can be positioned in a first cubicle 20 and the controller unit 16 and respective control electronics in a second cubicle 21. Said first and second cubicle 20 and 21, are preferably positioned next to each other, at a head side of the multi-stage compressor unit 1.

In other words, after being mounted, the first cubicle 20 and the second cubicle 21 define an axis B-B′, corresponding to the longest side of the housing. Preferably, the axis A-A′ is parallel or approximately parallel to the axis B-B′.

In another embodiment according to the present invention, and not limiting thereto, the second compressor stage 3 can be mounted in parallel with the first compressor stage 2.

In yet another embodiment according to the present invention, for an improved gas flow through the multi-stage compressor unit 1, the second compressor stage 3 can be rotated 180° with respect to the first compressor stage 2, as shown in FIG. 6. Consequently, the first motor 8 will be mounted in parallel with the second compressor element 10 and the second motor 13 will be mounted in parallel with the first compressor element 5.

Because of such a layout, the path of the gas while passing through the multi-stage compressor unit 1 becomes shorter.

In another embodiment according to the present invention, the first motor 8 and the second motor 13 can be either air or liquid cooled.

Preferably, for reasons of robustness, at least one of said first motor 8 and second motor 13 is liquid cooled.

Preferably, but not limiting thereto, both, the first motor 8 and the second motor 13 are liquid cooled.

In a preferred embodiment according to the present invention, but not limiting thereto, at least one of said first motor 8 and second motor 13 is cooled with the same liquid as the first compressor element 5 or second compressor element 10 that is driven by this first motor 8 or second motor 13, respectively.

For achieving an efficient cooling and a compact multi-stage compressor unit 1 necessitating a minimum number of components and connection means, at least one motor 8 and/or 13, and the compressor element 5 and/or 10, that are cooled with the same liquid, comprise a cooling circuit comprising said liquid, said cooling circuit being configured such that this motor 8 and/or 13, and the associated compressor element 5 and/or 10, are cooled in series.

Preferably, but not limiting thereto, each of the first motor 8 and second motor 13 comprise cooling channels through their motor housing, along the circumference of said motor housing, increasing the cooling efficiency.

Similarly, the compressor housing of each of said first compressor element 5 and second compressor element 10 can comprise cooling channels along the circumference of the respective compressor housing.

In another embodiment according to the present invention, for arriving at an even more compact multi-stage compressor unit 1, a compressed gas outlet of at least one of said first compressor element 5 or second compressor element 10 is connected to the cooling unit 15, and positioned on top of this cooling unit 15.

In another embodiment according to the present invention, the multi-stage compressor unit 1 further comprises a second cooling unit 22 positioned on the fluid conduit between the second compressor stage 3 and the user's network 4.

In a further preferred embodiment but not limiting thereto, the first compressor element 5 is positioned on top of the cooling unit 15 and the second compressor element 10 is positioned on top of the second cooling unit 22.

Preferably, but not limiting thereto, the connection between the first compressor element 5 and the cooling unit and/or the connection between the second compressor element 10 and the second cooling unit 22 is/are preferably configured to support said first compressor element 5 and/or said second compressor element 10.

In another embodiment according to the present invention, the first motor 8 driving the first compressor element 5 is positioned together with the first compressor element 5 on top of the cooling unit 15.

Further preferably but not limiting thereto, the second motor 13 driving the second compressor element 10, and the second compressor element 10 are positioned on top of the second cooling unit 22.

Preferably, but not necessarily, the cooling outlet of each of said first motor 8 and second motor 13 is connected to a cooling inlet of said cooling unit 15 or second cooling unit 22 respectively, or a cooling inlet of each of said first motor 8 and second motor 13 is connected to a cooling outlet of said cooling unit 15 or second cooling unit 22 respectively.

In another embodiment according to the present invention, the connection between one of said first compressor element 5 and/or said second compressor element 10 and the cooling unit 15 is realized by means of a connection part 28, said connection part 28 being configured to support this first compressor element 5 or second compressor element 10.

In another preferred embodiment according to the present invention and not limiting thereto, said at least one of said first compressor element 5 or second compressor element 10 is connected to the respective first motor 8 or second motor 13 by means of a second connection part, said second connection part being configured to support this first compressor element 5 or second compressor element 10. By adopting such a layout, the multi-stage compressor unit 1 according to the present invention is very compact. Moreover, an easy maintenance procedure can be achieved with an easy, standardized access to the different components.

In another embodiment according to the present invention, and not limiting thereto, the multi-stage compressor unit 1 can comprise two or more compressor elements driven by the first motor 8 and/or by the second motor 13 (not shown).

As an example, the first compressor stage 2 can comprise said first compressor element 5 and at least one additional compressor element (not shown) connected in series or in parallel with the first compressor element 5.

Similarly, the second compressor stage 3 can comprise said second compressor element 10 connected in series or in parallel with at least one additional compressor element (not shown).

Another possibility is for the multi-stage compressor unit 1 to comprise a connection to a first user's network, the first user's network receiving compressed gas from a branch-off connection from the compressed gas outlet 7 of the first compressor stage 2, for example.

Whereas, another user's network would receive compressed gas from a branch-off connection from the compressed gas outlet 12 of the second compressor stage 3.

The functioning of the multi-stage compressor unit 1 is very simple and as follows.

The multi-stage compressor unit 1 is switched on and the first motor 8 and the second motor 13 are rotating the rotors of the first compressor element 5 through the first gear-transmission 9 and rotors of the second compressor element 10 through the second gear-transmission 14 at a respective speed selected by the controller unit 16 such that the demand at the user's network 4 is met.

Preferably, the compressed gas outlet 7 of the first compressor stage 2 is connected to an inlet of a cooling unit 15 and a gas outlet of the cooling unit 15 to an inlet 11 of the second compressor element 10.

The pressure at the compressed gas outlet 7 of the first compressor stage 2 and at the compressed gas outlet 12 of the second compressor stage 3 are measured by means of a first pressure sensor 23 and a second pressure sensor 24 respectively, in step 100 of FIG. 7, and sent through the third communication link 19 to the controller unit 16.

In an embodiment according to the present invention, the controller unit 16 is preferably capable of adjusting the rotational speed of the first motor 8 based on the pressure measured at the compressed gas outlet 12 of the second compressor stage 3 and the rotational speed of the second motor 13 based on the pressure measured at the compressed gas outlet 7 of the first compressor stage 2.

The controller unit 16 will compare, in step 101, the measured pressure at the compressed gas outlet 12 of the second compressor stage 3, from step 124, with a first pressure reference, from step 102, corresponding to the required pressure at the compressed gas outlet 12 of the second compressor element 10 and therefore, the desired pressure at the user's network 4.

If the comparison reveals that the two values are different, the controller unit 16 determines the rotational speed of the first motor 8, in step 103 and generates an electrical signal through the first communication link 17 to the frequency converter of the first compressor stage 2, and adjusts the rotational speed of the first motor 8, step 104.

Based on the first pressure reference 102, the controller unit 16 identifies, in step 105, a second pressure reference, 104, at the level of the cooling unit 15, by considering the functioning pattern of the multi-stage compressor unit 1, determined during design.

It goes without saying that the controller unit 16 comprises a processing unit (not shown) capable of performing calculations and a memory unit (not shown) whereby different data and calculations can be stored.

Preferably, the functioning pattern of the multi-stage compressor unit 1 can be saved onto the memory unit before the compressor unit 1 is leaving the factory, or can be saved thereon at any moment after the compressor unit 1 leaves the factory.

The identified second pressure reference, step 104, is subsequently compared with the pressure measured at the compressed gas outlet 7 of the first compressor stage 2, in step 123. If the result of the comparison reveals that the two values are different, the controller unit 16 preferably determines the rotational speed of the second motor 13, in step 106, generates an electrical signal through the second communication link 18 to the frequency converter of the second compressor stage 3, and adjusts the rotational speed of the second motor 13, in step 107.

By adjusting the rotational speed, it should be understood that the electrical signal generated by the controller unit 16 determined the respective frequency converter to increase or decrease the rotational speed of the first motor or second motor 13 respectively such that the first pressure reference and/or the second pressure reference are reached.

The second pressure reference is preferably selected by the controller unit 16 such that a state of equilibrium between the first compressor stage 2 and the second compressor stage 3 is maintained.

In a preferred embodiment according to the present invention and not limiting thereto, the controller unit 16 comprises a Proportional Integral (PI) controller for determining the needed rotational speed of the first motor 8 and/or of the second motor 13.

In another embodiment according to the present invention, the controller unit 16 can comprise two PI controllers, each used for determining the speed of the first motor 8 and of the second motor 13 respectively.

These controllers performing the calculations in steps 103 and 106.

In another embodiment according to the present invention, and not limiting thereto, the method further comprises the step of adjusting the rotational speed of the second motor 13 by multiplying the rotational speed of the first motor 8 with a predefined gain, in step 108.

The predefined gain being determined from the functioning pattern of the multi-stage compressor unit 1.

In yet another embodiment and not limiting thereto, the method further comprises the step of adjusting the rotational speed of the second motor 13 by multiplying the rotational speed of the first motor 8 with a calculated gain, calculated by adding the predefined gain corresponding to an ideal situation to a determined gain calculated by a PI controller considering the measurements of the multi-stage compressor unit 1.

The predefined gain being calculated as a function of the rotational speed of the first motor 8 and the pressure desired at the user's network 4 considering a behavior of the multi-stage compressor unit 1 according to an ideal situation and based on a theoretical calculation model of the multi-stage compressor unit 1.

Whereas the determined gain is being calculated as a function of the rotational speed of the first motor 8 and the pressure desired at the user's network 4 considering the actual behavior of the multi-stage compressor unit 1.

By implementing such a method, a more accurate determination of the rotational speed of the second motor 13 is performed. Accordingly, a state of equilibrium of the multi-stage compressor unit 1 is maintained during its functioning.

Depending on the design of the multi-stage compressor unit 1, said multi-stage compressor unit 1 can comprise some or even all the technical features presented herein, in any combination without departing from the scope of the invention.

By technical features it is meant at least: the series connection between the compressor stages, the number of compressors included in each compressor stage and the connection thereof, the first and second compressor element and 10 can be selected as screw or tooth compressor elements, either oil free or oil injected, each of the first motor 8 and second motor 13 comprises a frequency converter, the usage of the functioning pattern, the use of a representation of the mass flow over pressure, at least one of the first motor 8 or second motor 13 is an electrical motor, at last one of the electrical motor is a motor with Variable Speed Drive (VSD), the positioning of the compressor element and the motor on top of the respective cooling unit 15 and/or 22, the multi-stage compressor unit 1 comprises: the cooling unit 15, the second cooling unit 22, the controller unit 16, the first communication link 17, the second communication link 18, the first pressure sensor 23, the first temperature sensor 25, the second pressure sensor 24, the second temperature sensor 26, the third communication link 19, the fourth communication link 27, the connection part 28, etc.

The present invention is in no way limited to the examples discussed above and shown in the drawings, however, a multi-stage compressor unit according to the present invention can be realized in all shapes and dimensions, without departing from the scope of the invention.

1.-29. (canceled)

30. A multi-stage compressor unit comprising:
an inlet and a compressed gas outlet,
at least a first compressor stage comprising a first compressor element driven by a first motor through a first gear-transmission and a second compressor stage comprising a second compressor element driven by a second motor through a separate second gear-transmission, wherein each of said first and said second gear transmissions comprises a driving gear connected to the first motor or the second motor respectively, and
a driven gear configured to be a multiplier, each of said driven gear being connected to a shaft of a rotor of said first compressor element or said second compressor element respectively,
wherein the first motor and the second motor are adapted to drive the first compressor stage and the second compressor stage separately,
wherein a gear ratio between the driven gear and the driving gear of either one of said first gear transmission and said second gear transmission is situated between two and six.

31. The multi-stage compressor unit according to claim 30, further comprising a cooling unit for cooling a compressed gas exiting the first compressor element or the second compressor element.

32. The multi-stage compressor unit according to claim 31, further comprising a controller unit connected to the first motor through a first communication link and to the second motor through a second communication link.

33. The multi-stage compressor unit according to claim 32, wherein the multi-stage compressor unit comprises a first pressure sensor and/or a first temperature sensor positioned at the compressed gas outlet of the first compressor element and a second pressure sensor and/or a second temperature sensor positioned at the compressed gas outlet of the second compressor element and the controller unit is adapted to receive measurement data from said pressure sensor(s) and/or temperature sensor(s) through a third communication link.

34. The multi-stage compressor unit according to claim 30, wherein at least one of said first motor and/or second motor is configured such that the product of the nominal power, in kW, and the square of the nominal speed, in rpm, is situated in a range between 0.0006×10E12 and 0.025×10E12.

35. The multi-stage compressor according to claim 30, wherein at least one of said motors is configured such that the product of the maximum power, in kW, and the square of the maximum speed, in rpm, is situated in a range between 0.0006×10E12 and 0.025×10E12.

36. The multi-stage compressor unit according to claim 30, wherein at least one of said compressor elements and the motor driving this at least one compressor element, are oriented transversally relative to the direction of longest side of the multi-stage compressor unit.

37. The multi-stage compressor unit according to claim 30, wherein said multi-stage compressor unit further comprises a first cubicle comprising one or more frequency convertors, and a second cubicle comprising control electronics, said first and second cubicle being separated from one another.

38. The multi-stage compressor unit according to claim 30, wherein at least one of said first motor or second motor is cooled with the same liquid as the first compressor element or second compressor element that is driven by this first motor or second motor.

39. The multi-stage compressor unit according to claim 38, wherein the at least one motor and the compressor element that are cooled with the same liquid comprise a cooling circuit comprising said liquid, said cooling circuit being configured such that this motor and the associated compressor element are cooled in series.

40. The multi-stage compressor unit according to claim 30, wherein a compressed gas outlet of at least one of said first compressor element or second compressor element is connected to a cooling unit, and positioned on top of this cooling unit.

41. The multi-stage compressor unit according to claim 40, wherein the first motor driving the first compressor element is positioned together with the first compressor element on top of the cooling unit and/or the second motor driving the second compressor element, and the second compressor element is positioned on top of the second cooling unit.

42. The multi-stage compressor unit according to claim 41, wherein said at least one of said first compressor element or second compressor element is connected to the respective first motor or second motor by means of a second connection part, said second connection part being configured to support this first compressor element or second compressor element.

43. The multi-stage compressor unit according to claim 38, wherein a cooling outlet of at least one of said first motor or second motor that is cooled in series with at least one of said first compressor element or second compressor element, is connected to a cooling inlet of a cooling unit.

44. The multi-stage compressor unit according to claim 38, wherein a cooling inlet of said at least one of said first motor or second motor that is cooled in series with at least one of said first compressor element or second compressor element, is connected to a cooling outlet of a cooling unit.

45. A multi-stage compressor unit comprising:
at least a first compressor element and a second compressor element and at least a first motor and a second motor for driving, each separately, another one of said first compressor element and said second compressor element through a separate first gear-transmission and a separate second gear-transmission,
each of said first gear-transmission and said second gear-transmission comprising a driving gear connected to a respective motor of said first motor or said second motor, and a driven gear being connected to a shaft of a rotor of one of said first compressor element or said second compressor element,
wherein a ratio between a number of teeth of the driving gear and a number of teeth of the driven gear of either one of said first gear-transmission and said second gear-transmission is situated between two and six.

46. A method for adjusting the rotational speed of the motors of a multi-stage compressor unit, wherein the method comprises the following steps:
providing a first compressor stage comprising a first compressor element and driving said first compressor element by means of a first motor through a first gear-transmission;
providing a second compressor stage comprising a second compressor element and driving said second compressor element separately from the first compressor element by means of a second motor through a separate second gear-transmission;
connecting a driving gear of each of the first gear-transmission and second gear-transmission to the first motor or second motor respectively;
connecting a driven gear of each of the first gear-transmission and second gear-transmission to a shaft of a rotor of said first compressor element or second compressor element respectively; and
setting a gear ratio between the driving gear and the driven gear of either one of said first gear-transmission and said second gear-transmission between two and six.

47. The method according to claim 46, further comprising the step of connecting a compressed gas outlet of the first compressor stage to an inlet of a cooling unit and a gas outlet of the cooling unit to an inlet of the second compressor stage and measuring a pressure at the compressed gas outlet of the first compressor stage and at the compressed gas outlet of the second compressor stage.

48. The method according to claim 47, further comprising the step of adjusting a rotational speed of the first motor based on the pressure measured at the compressed gas outlet of the second compressor stage and a rotational speed of the second motor based on the pressure measured at the compressed gas outlet of the first compressor stage.

49. The method according to claim 48, further comprising the steps of:
comparing the measured pressure at the compressed gas outlet of the second compressor stage with a first pressure reference corresponding to the required pressure at the compressed gas outlet of the multi-stage compressor unit and if the result of the comparison reveals that the two values are different, adjusting the rotational speed of the first motor; and/or
comparing the measured pressure at the compressed gas outlet of the first compressor stage with a second pressure reference corresponding to a desired value of the pressure at the level of the cooling unit and if the result of the comparison reveals that the two values are different, adjusting the rotational speed of the second motor.
